(19) United States
(12) Patent Application Publication
(10) Pub. No.: US 2019/0263458 A1
(43) Pub. Date: Aug. 29, 2019

(54) METHODS AND SYSTEMS FOR ACTIVE AERODYNAMIC BALANCE

(71) Applicant: GM GLOBAL TECHNOLOGY OPERATIONS LLC, DETROIT, MI (US)

(72) Inventors: Jason D. Fahland, Fenton, MI (US); Kevin Irwin, Royal Oak, MI (US); Dale Cattell, Royal Oak, MI (US); Samantha J. Bray, Northville, MI (US); Michael G. Petrucci, Howell, MI (US); Joshua R. Auden, Brighton, MI (US); Alexander MacDonald, White Lake, MI (US)

(21) Appl. No.: 15/907,940

(22) Filed: Feb. 28, 2018

(51) Int. Cl. B62D 37/02; B62D 35/00

(52) U.S. Cl. CPC B62D 37/02; B62D 35/005; B62D 35/007; B62D 35/008; B60Y 2300/022; B60Y 2400/40; B60Y 2400/304; B60Y 2400/3015; B60Y 2400/3017; B60Y 2400/302; B60Y 2400/303

(57) ABSTRACT

An exemplary method of controlling an automotive vehicle includes the steps of providing a first component, providing a second component movably coupled to the first component, providing an actuator coupled to the second component and configured to actuate the second component between a first position and a second position, providing a vehicle sensor configured to measure a vehicle characteristic, providing at least one controller in communication with the actuator and the vehicle sensor, and determining a baseline vehicle balance and determining an adjusted vehicle balance based on the measured vehicle characteristic.

### INTRODUCTION

The present invention relates generally to the field of vehicles and, more specifically, to aerodynamic features of automotive vehicles.

Recently, actively movable aerodynamic features have been implemented on some vehicles. However, the aerodynamic balance of the vehicle is affected by vehicle dynamics events such as braking and cornering. Vehicle performance may be improved by adjusting an aerodynamic balance.

### SUMMARY

Embodiments according to the present disclosure provide a number of advantages. For example, embodiments according to the present disclosure enable generation of an aerodynamic balance and/or downforce estimation based on vehicle characteristics such as, for example and without limitation, lateral and longitudinal acceleration, yaw error, trail braking, steering with acceleration, pitch gradient, axle torque, and suspension geometry.

In one aspect, a method of controlling an automotive vehicle includes providing a first component, providing a second component, the second component being movably coupled to the first component, providing an actuator coupled to the second component and configured to actuate the second component between a first position and a second position, providing a vehicle sensor configured to measure a vehicle characteristic, providing at least one controller in communication with the actuator and the vehicle sensor, and determining a baseline vehicle balance and determining an adjusted vehicle balance based on the measured vehicle characteristic.

In some aspects, the method further includes automatically controlling the actuator, via the at least one controller, to move the second component from the first position to the second position relative to the first component.

In some aspects, the first component includes a body structure of the automotive vehicle and the second component includes an aerodynamic member.

In some aspects, determining an adjusted vehicle balance includes calculating an aerodynamic balance adjustment with reference to data regarding one or more of an understeer gradient, a pitch gradient, and a steering wheel angle error, wherein the aerodynamic balance adjustment includes automatically controlling the actuator to move the aerodynamic member from the first position to the second position.

In some aspects, determining the baseline vehicle balance includes calculating the baseline vehicle balance with reference to one or more of a vehicle lateral acceleration and a vehicle axle torque.

In some aspects, determining an adjusted vehicle balance includes calculating a vehicle balance offset with reference to data regarding one or more of an understeer gradient, a pitch gradient, and a steering wheel angle error.

In some aspects, the vehicle characteristic includes one or more of a vehicle pitch condition, a vehicle roll condition, a vehicle yaw condition, a chassis position, a steering angle, a throttle position, a brake position, and an active suspension position.

In another aspect, a method of controlling an automotive vehicle includes the steps of providing a vehicle sensor configured to measure a vehicle characteristic, providing at least one controller in communication with the vehicle sensor, determining a baseline aerodynamic balance, and in response to a vehicle operating condition being satisfied, determining an adjusted aerodynamic balance.

In some aspects, the vehicle operating condition includes one or more of a vehicle suspension deflection and a tire deflection.

In some aspects, the vehicle characteristic includes one or more of a vehicle pitch condition, a vehicle roll condition, a vehicle yaw condition, a chassis position, a steering angle, a throttle position, a brake position, and an active suspension position.

In some aspects, determining the baseline aerodynamic balance includes calculating the baseline aerodynamic balance with reference to one or more of a vehicle lateral acceleration and a vehicle axle torque.

In some aspects, determining an adjusted aerodynamic balance includes calculating an aerodynamic balance offset with reference to data regarding one or more of an understeer gradient, a pitch gradient, and a steering wheel angle error.

In some aspects, the method further includes the steps of providing an aerodynamic member, providing an actuator coupled to the aerodynamic member and configured to actuate the aerodynamic member between a first position and a second position, and wherein determining an adjusted aerodynamic balance includes calculating an aerodynamic balance adjustment with reference to data regarding one or more of an understeer gradient, a pitch gradient, and a steering wheel angle error, and wherein the aerodynamic balance adjustment includes automatically controlling the actuator to move the aerodynamic member from the first position to the second position.

In yet another aspect, an automotive vehicle includes a body having an exterior surface, at least one vehicle sensor configured to measure a vehicle characteristic, an aerodynamic member movably coupled to the exterior surface, the aerodynamic member having a first position with respect to the exterior surface and a second position with respect to the exterior surface, the first position presenting a distinct aerodynamic profile from the second position, an actuator coupled to the aerodynamic member and configured to actuate the aerodynamic member between the first position and the second position, at least one controller in communication with the actuator and the at least one vehicle sensor, the at least one controller being configured to control the actuator to move the aerodynamic member from the first position to the second position, wherein the at least one controller determines a baseline aerodynamic balance and in response to a vehicle operating condition being satisfied, determines an adjusted aerodynamic balance.

In some aspects, the vehicle operating condition includes one or more of a vehicle suspension deflection and a tire deflection.

In some aspects, the vehicle characteristic includes one or more of a vehicle pitch condition, a vehicle roll condition, a vehicle yaw condition, a chassis position, a steering angle, a throttle position, a brake position, and an active suspension position.

In some aspects, determining the baseline aerodynamic balance includes calculating the baseline aerodynamic balance with reference to one or more of a vehicle lateral acceleration and a vehicle axle torque.

In some aspects, determining an adjusted aerodynamic balance includes calculating an aerodynamic balance offset with reference to data regarding one or more of an understeer gradient, a pitch gradient, and a steering wheel angle error.

### BRIEF DESCRIPTION OF THE DRAWINGS

The present disclosure will be described in conjunction with the following figures, wherein like numerals denote like elements.

FIG. 1 is a schematic illustration of a vehicle, according to an embodiment of the present disclosure.

FIG. 2 is a schematic representation of a control system for an aerodynamic system, according to an embodiment of the present disclosure.

FIG. 3 is a flowchart representation of a method for determining an aerodynamic balance of a vehicle, according to an embodiment of the present disclosure.

FIG. 4 is a flowchart representation of a method for adjusting an aerodynamic balance of a vehicle, according to an embodiment of the present disclosure.

FIG. 5 is a flowchart representation of another method for adjusting an aerodynamic balance of a vehicle, according to an embodiment of the present disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications

of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Aerodynamic balance (“aero balance”) refers to a state of equilibrium between the downforce on the front wheels of a vehicle and the downforce on the rear wheels. Excess pressure at the front of the vehicle can cause oversteer; excess pressure at the rear of the vehicle can cause understeer. Furthermore, braking operations, cornering, or other vehicle dynamics events can affect the vehicle's balance, stability, and performance. Methods discussed herein analytically determine a baseline aerodynamic balance and refine the aero balance from vehicle dynamics information.

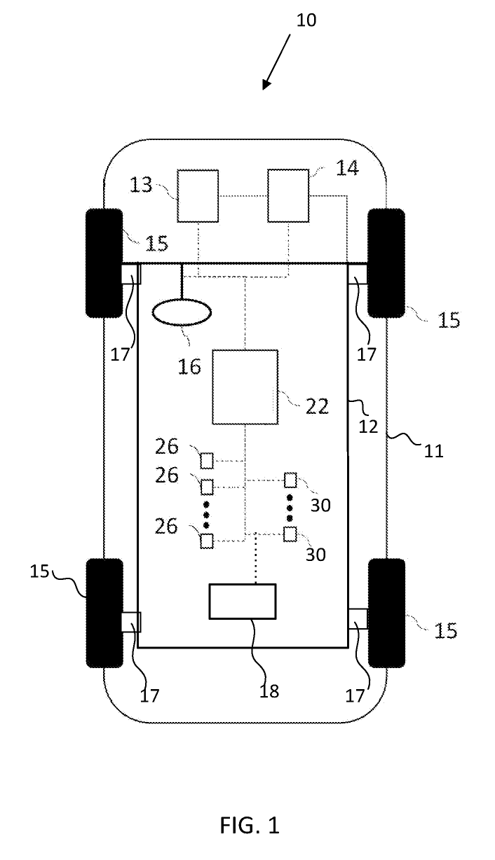

Referring now to FIG. 1, an automotive vehicle 10 according to the present disclosure is schematically illustrated. The vehicle 10 generally includes a body 11 and wheels or tires 15. The body 11 encloses the other components of the vehicle 10. The vehicle 10 also generally includes a chassis 12. The body 11 is coupled to the chassis 12. The wheels 15 are each rotationally coupled to the body 11 near a respective corner of the body 11. The vehicle 10 is depicted in the illustrated embodiment as a passenger car, but it should be appreciated that any other vehicle, including motorcycles, trucks, sport utility vehicles (SUVs), or recreational vehicles (RVs), etc., can also be used.

The vehicle 10 includes a propulsion system 13, which may in various embodiments include an internal combustion engine, an electric machine such as a traction motor, and/or a fuel cell propulsion system. The vehicle 10 also includes a transmission 14 configured to transmit power from the propulsion system 13 to the plurality of vehicle wheels 15 according to selectable speed ratios. According to various embodiments, the transmission 14 may include a step-ratio automatic transmission, a continuously-variable transmission, or other appropriate transmission. The vehicle 10 additionally includes wheel brakes (not shown) configured to provide braking torque to the vehicle wheels 15. The wheel brakes may, in various embodiments, include friction brakes, a regenerative braking system such as an electric machine, and/or other appropriate braking systems. The vehicle 10 additionally includes a steering system 16. While depicted as including a steering wheel and steering column for illustrative purposes, in some embodiments, the steering system 16 may not include a steering wheel. The vehicle 10 additionally includes one or more suspension system components 17 positioned, in some embodiments, adjacent to the plurality of vehicle wheels 15. In some embodiments, as shown in FIG. 1, a suspension system component 17 is positioned adjacent to each of the wheels 15.

With further reference to FIG. 1, the vehicle 10 also includes a plurality of sensors 26 configured to measure and capture data on one or more vehicle characteristics, including but not limited to vehicle speed, steering wheel angle, vehicle pitch angle, vehicle yaw, tire pressure, temperature, and/or acceleration (including vertical acceleration), vertical displacement, and vehicle acceleration. In the illustrated embodiment, the sensors 26 include, but are not limited to, an accelerometer, a speed sensor, a tire pressure/acceleration monitoring sensor, a displacement sensor (such as, for example and without limitation, a lower control arm displacement sensor), an acceleration sensor (such as, for example and without limitation, a lower control arm acceleration sensor and/or an upper mount acceleration sensor), gyroscope, steering angle sensor, or other sensors that sense observable conditions of the vehicle or the environment surrounding the vehicle and may include RADAR, LIDAR, optical cameras, thermal cameras, ultrasonic sensors, infrared sensors, light level detection sensors, and/or additional sensors as appropriate. In some embodiments, the vehicle 10 also includes a plurality of actuators 30 configured to receive control commands to control steering, shifting, throttle, braking, the position of an aerodynamic member or other aspects of the vehicle 10.

The vehicle 10 includes at least one controller 22. While depicted as a single unit for illustrative purposes, the controller 22 may additionally include one or more other controllers, collectively referred to as a “controller.” The controller 22 may include a microprocessor or central processing unit (CPU) or graphical processing unit (GPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

In some embodiments, the vehicle 10 includes at least one aerodynamic member 18. In some embodiments, the aerodynamic member is a wing-shaped spoiler, however, the aerodynamic member 18 may be any shape configured to generate aerodynamic downforce. “Wing-shaped” as used herein refers to an object having a shape of a wing, i.e., a fin having an airfoil shape defined by a streamlined cross-sectional shape configured to produce lift or downforce. The term “spoiler” means an aerodynamic device capable of disrupting air movement across the vehicle body while the vehicle 10 is in motion, thereby reducing drag and/or inducing an aerodynamic downforce F on the vehicle 10. The term “downforce” means a force component that is perpendicular to the direction of relative motion of the vehicle 10, i.e., in the longitudinal direction, toward the road surface. The aerodynamic member 18 may be formed from a suitably rigid but low mass material, such as an engineered plastic or aluminum, for structural stability.

In various embodiments considered within the scope of the present disclosure, the aerodynamic member 18 can include one or more of a spoiler or a wing disposed at any location along a top of the vehicle 10, a dive wing disposed at any location along a corner of the vehicle 10, a gurney flap disposed at any location along the fore portion of the vehicle 10 or disposed on a spoiler, a front splitter disposed at any location along the fore portion of the vehicle 10, a front air dam disposed at any location along the fore portion of the vehicle 10, other aerodynamic members, or combination thereof. Each of the aerodynamic members 18 can include one or more of the features discussed herein for the single aerodynamic member 18.

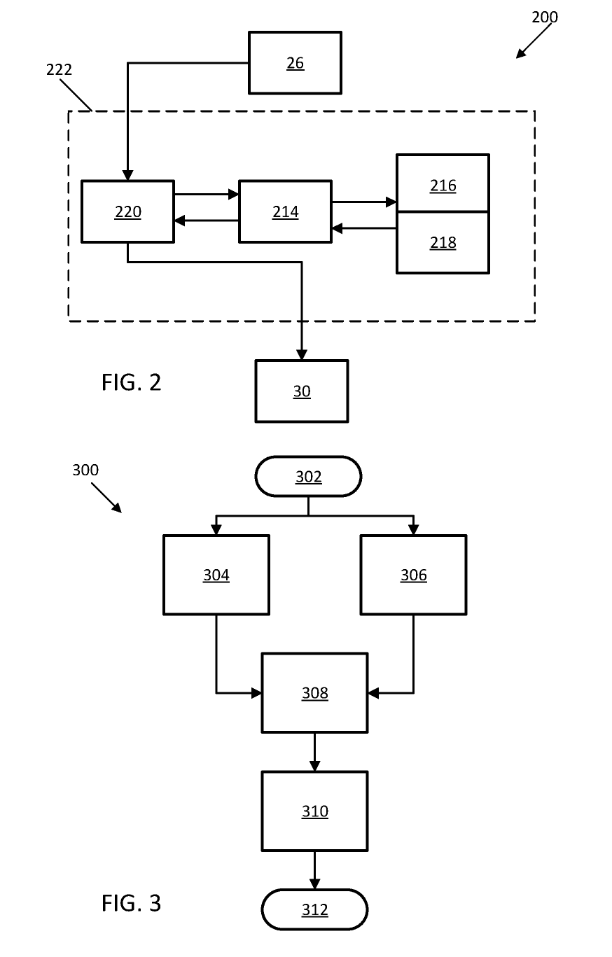

FIG. 2 illustrates an exemplary control system 200 for controlling an aerodynamic system. A processor/controller device 222 includes a central processing unit 214 coupled to memory devices 216, 218, which can include such memory as random access memory (RAM) 216, non-volatile read only memory (NVROM) 218, and possibly other mass storage devices. In some embodiments, the controller device 222 is the controller 22. In some embodiments, the controller device 222 is a controller separate from the controller 22. The CPU 214 is coupled through an input/output (I/O) interface 220 to at least one of a plurality of sensors, such as the sensors 26, of the vehicle 10. The sensors 26 are configured to measure various operational parameters of the vehicle 10. In some embodiments, the CPU 214 is coupled through the I/O interface 220 to an inertial measurement unit 224 including one or more sensors 26. The controller 222 generates one or more control signals and transmits the control signals to one or more actuators, such as the actuators 30, via, in some embodiments, the I/O interface 220.

In some embodiments, the aerodynamic member 18 is part of an aerodynamic control system including one or more actuators 30 and a controller, such as the controller 22 or the controller 222. In some embodiments, the aerodynamic control system includes one or more aerodynamic members 18.

Lateral and longitudinal acceleration affect vehicle stability in different ways and therefore a different aero balance is initially determined to optimize performance. Determining the aero balance for the vehicle considering vehicle dynamics events individually, such as only braking, only cornering, or only acceleration, is straightforward, but determining the aero balance for a combined maneuver increases the complexity. In some embodiments, a lookup table provides a way of combining lateral and longitudinal acceleration information from vehicle acceleration, cornering, and braking information acquired from one or more vehicle sensors, such as the sensors 26, to generate a more accurate baseline aero balance. In some embodiments, the aero balance determination can be modified by factors such as, for example and without limitation, steering wheel angle gradient, to further hone the aero balance of the vehicle. The baseline aero balance determination based on simultaneous inputs of lateral and longitudinal acceleration may lead to reduced stopping distance and increased braking confidence in addition to improved vehicle control.

In some embodiments, a lookup table provides a way of combining axle torque and desired lateral acceleration information to generate the baseline aero balance. For example, in one embodiment, a driveline torque is obtained and assigned a possible value and an estimated brake torque corresponding to the same axle as the driveline torque is determined from a master cylinder pressure and assigned a negative value. The sum of the driveline torque and the estimated brake torque result in a positive or negative signed driven axle torque value. The more negative the value of the driven axle torque, the greater the amount of desired braking. Conversely, the more positive the value of the driven axle torque, the greater the amount of desired acceleration. If the driven axle torque value is approximately zero, neither braking nor acceleration is desired (that is, the operator is not applying the vehicle brakes or the vehicle accelerator).

Given a relationship between the amount of axle torque and aero balance, a lookup table can be used to determine a baseline aero balance, including, in some embodiments, an amount of forward or rearward aero balance to be applied to the vehicle to reduce or prevent oversteer or understeer conditions and improve vehicle handling.

In some embodiments, such as, for example, all-wheel drive (AWD) vehicles, a front axle applied torque is subtracted from a rear axle applied torque. In some embodiments, this subtraction may include an offset. This calculation results in an effective axle torque. The effective axle torque reflects an overall net torque effect on the vehicle and is used, in some embodiments, with an aero balance lookup table to determine a baseline aero balance of the vehicle.

In an exemplary embodiment, a method for achieving and managing a baseline aero balance with mostly feed-forward (that is, predictive) and simple to calibrate controls includes tuning the desired balance while only accelerating, only braking, and only cornering to obtain a baseline aero balance using a two-axis lookup table in which the intermediate points are generated through interpolation. In some embodiments, the lookup table is stored in accessible memory of the controller, such as the memory 216, 218 of the controller 222. The lookup table may also be used to further refine the vehicle's aero balance.

Referring now to FIG. 3, a method 300 of controlling an aerodynamic control system according to the present disclosure is illustrated in flowchart form. In some embodiments, a controller, such as the controller 22 or the controller 222, receives a first input, such as a lateral acceleration of the vehicle and a second input, such as a longitudinal acceleration of the vehicle and from this input information, determines a baseline vehicle aerodynamic balance. In some embodiments, a first input such as axle torque and a second input such as desired lateral acceleration are received by the controller and used to determine a baseline vehicle aerodynamic balance.

Beginning at 302, the method 300 proceeds simultaneously to 304 and 306. At 304, the controller 222 receives vehicle lateral acceleration data. At 306, the controller 222 receives vehicle longitudinal acceleration data. Next, at 308, the controller 222 compares the acceleration data with a lookup table to generate a baseline aerodynamic balance of the vehicle 10, as represented by 310. The method 300 then proceeds to 312 and ends.

In some embodiments, the lookup table is a single two-axis table including data representing vehicle behavior due to cornering, braking, and acceleration. In some embodiments, two or more lookup tables are accessed to determine the baseline aero balance of the vehicle 10. As discussed in greater detail herein, this baseline aerodynamic balance is adjusted based on various vehicle dynamics factors to further refine the aero balance and improve vehicle performance based on current vehicle operating conditions.

In some embodiments, an adjustment to the vehicle and/or aero balance is made based on the amount of reported vehicle understeer. Vehicle understeer and oversteer are vehicle dynamics terms used to describe the sensitivity of a vehicle to steering. Oversteer occurs when the vehicle turns or steers by more than the amount commanded by the operator. Conversely, understeer occurs when the vehicle steers less than the amount commanded by the operator.

In one example, the vehicle enters a corner initially with a feed-forward (that is, predictive-based) baseline aero balance, such as the baseline aero balance determined at step 310 of the method 300. While entering the turn, in some instances, something in the environment changes slightly and/or the operator deviates from an expected behavior such as, for example, a bump is encountered, or the operator alters the steering angle, etc. At this moment, if understeer is detected by the vehicle controller 22, the aerodynamic member 18 will be controlled to apply more downforce to the front of the vehicle 10 to move the balance forward and enable the vehicle 10 to turn in. If oversteer is detected by the vehicle controller 22, the aerodynamic member 18 is controlled to achieve the opposite reaction, that is, pulling downforce rearward of the vehicle 10. The more understeer or oversteer detected by the vehicle sensors 26, the greater the adjustment to the baseline aero balance. However, in some embodiments, safety limits in the form of calibrations are imposed to avoid the application of too much forward or rearward downforce. In some embodiments, adjustment to the vehicle balance is made via adjustments to the vehicle suspension (for example, changes to damper stiffness, etc.) rather than through adjustment of an active aerodynamic member.

A balanced application of forward or rearward downforce is achieved by estimating the understeer behavior of the vehicle 10 and feeding the estimated data into a lookup table. In some embodiments, a “dead zone” is determined in which no aero balance adjustments are made to the vehicle 10 and an output is generated that will either scale or offset the baseline aero balance accordingly.

Desired aero balance during straight-line braking events is often very different than mid-corner (quasi-steady state) aero balance to achieve maximum lateral acceleration. Often, the transition between the two types of braking events is difficult to calibrate considering varying driving styles and driving methods, such as trail braking. Trail braking is a braking technique in which brake pressure is applied past the corner entrance during a turn, creating a weight transfer toward the front tires, thus increasing their traction and reducing understeer. Because of the characteristics of this weight transfer, trail braking causes weight to be shifted away from the rear of the car, resulting in lower rear traction and can be used to induce oversteer in some cases.

In some embodiments, vehicle aero balance is shifted forward while the vehicle is in the lower region of driver-applied brake pressure during a trail brake maneuver. Increased brake pressure in a cornering maneuver can unbalance the vehicle. If brake pressure increases, an adjustment to the aero and/or vehicle balance can assist to rebalance the vehicle in preparation for a different maneuver. In some embodiments, the vehicle can be stabilized using an aero balance that is dynamically adjusted during a faster than normal turn maneuver.

In some embodiments, a lookup table is used to determine the amount of aero load or downforce to apply based on driver actions such as, for example and without limitation, applied brake pressure, brake pedal position, brake torque, corner brake pressure, driver-intended master cylinder brake pressure, or any combination thereof. In some embodiments, a lookup table used to determine an amount by which to scale or offset the baseline aero balance based on vehicle operating data obtained from one or more of the sensors 26, including yaw rate error, steering wheel angle, steering wheel gradient, vehicle pitch angle, acceleration torque, lateral acceleration, and tire temperature, for example and without limitation.

Generally, mid-corner vehicle balance is relatively steady but if the operator decides the vehicle is excessively understeering or miscalculates corner entry and wants to make up for the miscalculation mid-turn, the driver might take other actions, such as braking or acceleration, that may unbalance the vehicle. On corner entry, this action could be in the form of trail braking. Throttle application applied mid-corner and into corner exit will rotate the vehicle by reducing the lateral capacity of the rear tires due to the additional longitudinal force. Methods discussed herein assist the driver steering the vehicle with the accelerator pedal while cornering in such a way as to enable the desired amount of rotation. If the throttle is over-applied, the calculated aero balance offset output will compensate and the controller will be directed to apply more downforce rearward of the vehicle, in an effort to keep the rear of the vehicle in close contact with the ground. In some embodiments, one or more of axle torque, accelerator position, longitudinal acceleration or a combination thereof are used as inputs to the aero balance determination.

The forward pitch gradient (that is, a rate of change of dive) may vary depending on how hard the driver is braking, the grade the vehicle is on, how the vehicle is loaded, etc. In some embodiments, adjustment of an aerodynamic member, such as the aerodynamic member 18, can have some effect on the forward pitch gradient by adjusting aero loads more rearward than originally targeted if a higher rate of pitch change than intended is observed. Moving the aero loads rearward aids in stabilizing the vehicle especially in rapid deceleration scenarios, such as, for example, scenarios an operator might see when operating the vehicle on a track. This adjustment to the aero loads on the vehicle can lead to reduced stopping distance and increased braking confidence in addition to improving vehicle control.

In some embodiments, the methods discussed herein assist the driver during relatively straight-line braking. In some embodiments, the methods discussed herein reference a lookup table that outputs a desired balance or balance offset based on the pitch gradient of the vehicle. In some embodiments, vehicle pitch, brake pressure, torque or pedal position gradient, longitudinal acceleration or any combination thereof are used as inputs to determine the desired aero and/or vehicle balance or to improve the aero balance determination from the lookup table. In some embodiments, the lookup table is calibrated in accordance with different vehicle platforms. While the methods discussed herein are intended as an offset to a base target braking balance, in some embodiments, the methods are used to generate an actual aero balance command, instead of an offset.

In some embodiments, suspension geometry, spring rates, vehicle ride height, and tire deflection are used to estimate total vehicle downforce. The estimated downforce is compared to aero maps and/or load sensors to adjust the vehicle aero balance by controlling the position of one or more aero control surfaces, such as the aerodynamic member 18. The methods discussed herein may assist in finding and/or reducing downforce estimation error due to airflow disturbances that could otherwise not be detected without the use of expensive load sensors. The methods discussed herein may also aid in identifying degraded, worn, or blocked downforce-generating surfaces, especially underneath the vehicle. Additionally, the methods discussed herein could be used with vehicles such as trucks and SUVs to detect load changes and/or load placement changes and react accordingly by adjusting chassis controls calibrations to optimize handling and powertrain calibrations to optimize fuel economy.

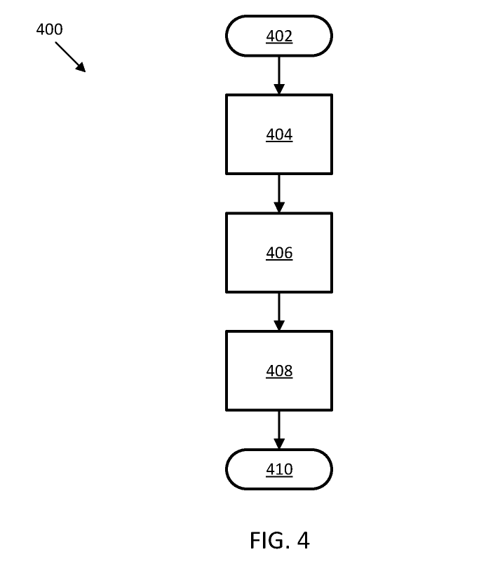

Referring now to FIG. 4, a method 400 for controlling an aerodynamic control system according to the present disclosure is illustrated in flowchart form. In some embodiments, a controller, such as the controller 22 or the controller 222, receives baseline vehicle aerodynamic balance data and/or baseline vehicle balance data and, using vehicle characteristic data obtained from one or more of the sensors 26 indicating a vehicle operating condition, determines an aero and/or vehicle balance offset and/or adjustment.

Beginning at 402, the method 400 proceeds to 404. At 404, the controller 222 receives and/or determines a baseline aero and/or vehicle balance, such as the baseline aero balance 310. In some embodiments, at 404, the controller 222 receives a baseline vehicle balance from the vehicle controller 22. In some embodiments, the controller 222 receives vehicle characteristic data from one or more of the vehicle sensors 26 and uses the vehicle characteristic data to determine a baseline vehicle balance.

After determining or receiving a baseline aero and/or vehicle balance, the method 400 proceeds to 406. At 406, the controller 222 receives vehicle dynamics data from one or more of the vehicle sensors 26. The vehicle characteristic data includes data regarding vehicle understeer or oversteer and, in some embodiments, includes data regarding the understeer gradient, as well as other vehicle dynamics information including but not limited to vehicle speed and lateral acceleration. A positive gradient indicates an understeer condition while a negative gradient indicates an oversteer condition. The value of the gradient provides an estimate of the understeer behavior of the vehicle 10.

Next, at 408, the controller 222 determines an aero and/or vehicle balance offset including, in some embodiments, an aero balance commanded that includes a calculated amount of downforce to apply to the fore or rear of the vehicle 10. In some embodiments, the vehicle characteristic data regarding the estimated understeer condition is used in conjunction with a lookup table to determine a scaling or offset value to be applied to the baseline aero and/or vehicle balance. The method 400 then proceeds to 410 and ends.

While the method 400 incorporates a lookup table to analytically offset or modify a predictive (that is, feedforward) aero and/or vehicle balance, any analytic method can be used individually or in conjunction with the method 400 to improve the estimated baseline aero and/or vehicle balance.

In some embodiments, the methods discussed herein simultaneously increase downforce estimation fidelity, optimize vehicle handling, and optimize transmission shift points without adding additional sensors to the vehicle. The methods discussed herein therefore improve performance, vehicle safety, and emissions/fuel economy without adding to the vehicle cost.

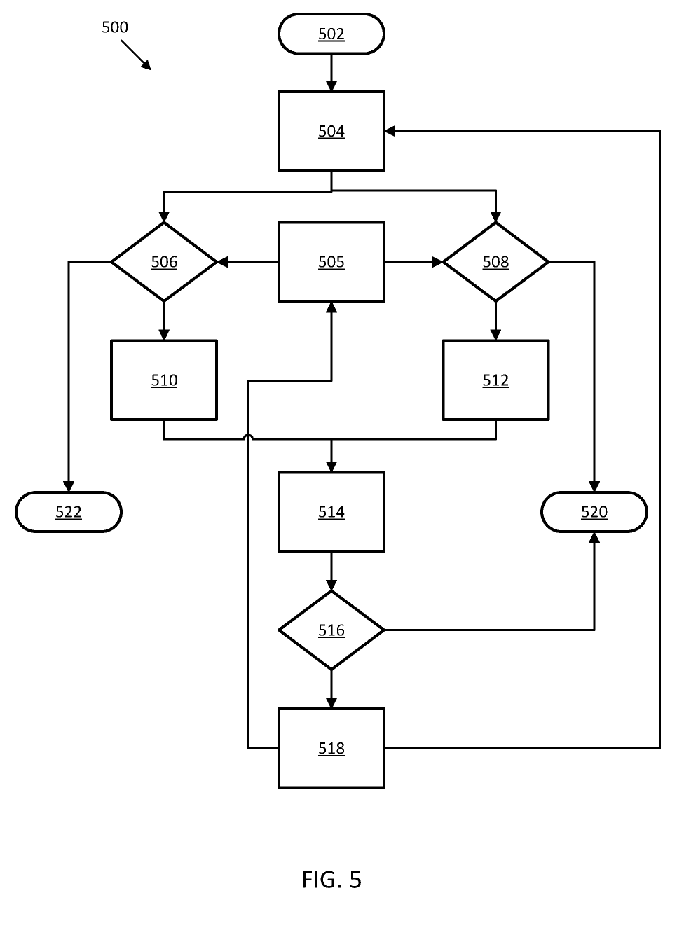

Referring now to FIG. 5, a method 500 for controlling an aerodynamic control system according to the present disclosure is illustrated in flowchart form. In some embodiments, a controller, such as the controller 22 or the controller 222, receives baseline vehicle aerodynamic balance data and/or baseline vehicle balance data and, using vehicle characteristic data obtained from one or more of the sensors 26 indicating a vehicle operating condition, determines an aero and/or vehicle balance offset and/or adjustment.

Beginning at vehicle key up, indicated by 502, the method 500 proceeds to 504. At 504, the controller receives and/or determines a baseline aero and/or vehicle balance, such as the baseline aero balance 310 discussed with regard to method 300. In some embodiments, at 504, the controller receives a baseline vehicle and/or aero balance from the vehicle controller 22. In some embodiments, the controller receives vehicle dynamics data from one or more of the vehicle sensors 26 and uses the vehicle dynamics data to determine a baseline vehicle and/or aero balance. In some embodiments, the baseline aero and/or vehicle balance is a stored nominal calibration optimized for load and balance of the vehicle 10. Vehicle load and balance data are acquired, in some embodiments, from one or more of the sensors 26.

The method 500 then proceeds to 506 and 508. At 506, the controller receives vehicle data from one or more of the sensors 26 including data on suspension deflection (such as, for example and without limitation, a suspension damper spring constant, suspension geometry, and suspension component differences from baseline, nominal values) and tire deflection (including, for example and without limitation, data mapping tire temperature and pressure to various vehicle load values), indicated by 505. From the vehicle data, the controller determines whether the vehicle load is above a threshold load value. In some embodiments, the threshold load value defines a maximum vehicle load based on the vehicle type and configuration. Similarly, at 508, the controller analyzes the vehicle data and determines whether the vehicle balance is outside of a predetermined balance range. The predetermined balance range defines, in some embodiments, an acceptable vehicle balance considering, for example and without limitation, vehicle stability and performance.

If the vehicle load is not above the threshold value, the method 500 proceeds to 522 and ends. Similarly, if the vehicle balance is within the predetermined balance range, the method 500 proceeds to 520 and ends.

However, if, at 506, the vehicle load is above the threshold load value, the method 500 proceeds to 510. At 510, the controller, such as the controller 22 or the controller 222, determines and optimizes one or more powertrain controls. The powertrain controls include, for example and without limitation, calculated engine and/or transmission calibration shifts, change maps, etc. In some embodiments, the controller generates one or more control signals to control aspects of the propulsion system.

If, at 508, the vehicle balance is outside the predetermined balance range, the method 500 proceeds to 512. At 512, the controller determines and optimizes one or more chassis controls. The chassis controls include, for example and without limitation, calculated calibration shifts, change maps, etc. In some embodiments, the controller generates one or more control signals to control aspects of the suspension system, such as, for example and without limitation, adjusting a damper stiffness.

From both 510 and 512, the method 500 proceeds to 514. At 514, the controller analyzes the vehicle data and optimized powertrain and chassis control data and determines an optimized aero and/or vehicle balance to improve vehicle handling, stability, and performance. In some embodiments, determining the optimized balance includes analyzing vehicle data including but not limited to downforce aero delta and balance delta. In some embodiments, the optimized balance includes determining a position or setting of an aerodynamic system component, such as the aerodynamic member 18.

Next, at 516, the controller determines whether to change the position of an aerodynamic control surface, such as the position of the aerodynamic member 18, from a first position to a second position, based on the optimized balance determined at 514. If the controller determines that the optimized balance includes a change to the position of the aerodynamic member 18, at 518 the controller generates a control signal that is transmitted to the actuator 30 to change the position of the aerodynamic member 18. Additionally, data regarding the new position of the aerodynamic member 18 is considered as part of the vehicle data gathered at 505 and is analyzed as the method 500 proceeds as discussed herein. From 518, the method 500 returns to 504 and proceeds as discussed herein.

However, if the controller determines that the optimized balance can be achieved without a change to an aerodynamic control surface, the method 500 proceeds to 520 and ends.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5. but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling an automotive vehicle, comprising:
providing a first component;
providing a second component, the second component being movably coupled to the first component;
providing an actuator coupled to the second component and configured to actuate the second component between a first position and a second position;
providing a vehicle sensor configured to measure a vehicle characteristic;
providing at least one controller in communication with the actuator and the vehicle sensor; and
determining a baseline vehicle balance and determining an adjusted vehicle balance based on the measured vehicle characteristic.

2. The method of claim 1 further comprising automatically controlling the actuator, via the at least one controller, to move the second component from the first position to the second position relative to the first component.

3. The method of claim 2, wherein the first component includes a body structure of the automotive vehicle and the second component includes an aerodynamic member.

4. The method of claim 3, wherein determining an adjusted vehicle balance comprises calculating an aerodynamic balance adjustment with reference to data regarding one or more of an understeer gradient, a pitch gradient, and a steering wheel angle error, wherein the aerodynamic balance adjustment comprises automatically controlling the actuator to move the aerodynamic member from the first position to the second position.

5. The method of claim 1, wherein determining the baseline vehicle balance comprises calculating the baseline vehicle balance with reference to one or more of a vehicle lateral acceleration and a vehicle axle torque.

6. The method of claim 1, wherein determining an adjusted vehicle balance comprises calculating a vehicle balance offset with reference to data regarding one or more of an understeer gradient, a pitch gradient, and a steering wheel angle error.

7. The method of claim 1, wherein the vehicle characteristic includes one or more of a vehicle pitch condition, a vehicle roll condition, a vehicle yaw condition, a chassis position, a steering angle, a throttle position, a brake position, and an active suspension position.

8. A method of controlling an automotive vehicle, comprising:
providing a vehicle sensor configured to measure a vehicle characteristic;
providing at least one controller in communication with the vehicle sensor;
determining a baseline aerodynamic balance; and
in response to a vehicle operating condition being satisfied, determining an adjusted aerodynamic balance.

9. The method of claim 8, wherein the vehicle operating condition includes one or more of a vehicle suspension deflection and a tire deflection.

10. The method of claim 8, wherein the vehicle characteristic includes one or more of a vehicle pitch condition, a vehicle roll condition, a vehicle yaw condition, a chassis position, a steering angle, a throttle position, a brake position, and an active suspension position.

11. The method of claim 8, wherein determining the baseline aerodynamic balance comprises calculating the baseline aerodynamic balance with reference to one or more of a vehicle lateral acceleration and a vehicle axle torque.

12. The method of claim 8, wherein determining an adjusted aerodynamic balance comprises calculating an aerodynamic balance offset with reference to data regarding one or more of an understeer gradient, a pitch gradient, and a steering wheel angle error.

13. The method of claim 8, further comprising:
providing an aerodynamic member;
providing an actuator coupled to the aerodynamic member and configured to actuate the aerodynamic member between a first position and a second position; and
wherein determining an adjusted aerodynamic balance comprises calculating an aerodynamic balance adjustment with reference to data regarding one or more of an understeer gradient, a pitch gradient, and a steering wheel angle error; and
wherein the aerodynamic balance adjustment comprises automatically controlling the actuator to move the aerodynamic member from the first position to the second position.

14. An automotive vehicle, comprising:
a body having an exterior surface;
at least one vehicle sensor configured to measure a vehicle characteristic;
an aerodynamic member movably coupled to the exterior surface, the aerodynamic member having a first position with respect to the exterior surface and a second position with respect to the exterior surface, the first position presenting a distinct aerodynamic profile from the second position;
an actuator coupled to the aerodynamic member and configured to actuate the aerodynamic member between the first position and the second position; and
at least one controller in communication with the actuator and the at least one vehicle sensor, the at least one controller being configured to control the actuator to move the aerodynamic member from the first position to the second position;
wherein the at least one controller determines a baseline aerodynamic balance and in response to a vehicle operating condition being satisfied, determines an adjusted aerodynamic balance.

15. The automotive vehicle of claim 14, wherein the vehicle operating condition includes one or more of a vehicle suspension deflection and a tire deflection.

16. The automotive vehicle of claim 14, wherein the vehicle characteristic includes one or more of a vehicle pitch condition, a vehicle roll condition, a vehicle yaw condition, a chassis position, a steering angle, a throttle position, a brake position, and an active suspension position.

17. The automotive vehicle of claim 14, wherein determining the baseline aerodynamic balance comprises calculating the baseline aerodynamic balance with reference to one or more of a vehicle lateral acceleration and a vehicle axle torque.

18. The automotive vehicle of claim 14, wherein determining an adjusted aerodynamic balance comprises calculating an aerodynamic balance offset with reference to data regarding one or more of an understeer gradient, a pitch gradient, and a steering wheel angle error.
